(19) United States
(12) Patent Application Publication
(10) Pub. No.: US 2014/0344410 A1
(43) Pub. Date: Nov. 20, 2014

(54) FIXED-LENGTH SEGMENTATION FOR SEGMENTED VIDEO STREAMING TO IMPROVE PLAYBACK RESPONSIVENESS

(71) Applicants: Thomas Jefferson Saremi, Mississauga (CA); Michael Podolsky, Thornhill (CA)

(72) Inventors: Thomas Jefferson Saremi, Mississauga (CA); Michael Podolsky, Thornhill (CA)

(73) Assignee: MOREGA SYSTEMS INC., Toronto (CA)

(21) Appl. No.: 13/893,981

(22) Filed: May 14, 2013

(51) Int. Cl. H04L 29/06

(52) U.S. Cl. CPC H04L 65/60
USPC 709/219

(57) ABSTRACT

A server includes a network interface to communicatively couple with a client device via a network, and a transport protocol interface to manage request and response transmissions with the client device via the network interface in accordance with a transport protocol. The server provides a content length indicator for transmission to the client device via the transport protocol interface in response to a request for a video segment of a video program from the client device. The content length indicator includes an estimated segment size of the video segment based on a specified playback duration associated with the video segment. The server streams, via the transport protocol interface, a set of video segment packets of the video program for reception by the client device as the requested video segment, wherein the streamed set of video segment packets has an aggregate data size equal to the estimated segment size.

### FIELD OF THE DISCLOSURE

The present disclosure relates generally to distribution of video over a network and more particularly to segmented streaming of video between a server and a client.

### BACKGROUND

The HyperText Transfer Protocol (HTTP) Live Streaming (HLS) standard provides for the segmentation of a video program by a video server into a sequence of smaller video segments. The server may provide to a client device a playlist, or “index file,” listing separate identifiers (typically uniform resource identifiers (URIs)) for each these video segments. Using this playlist and the segment URIs listed therein, the client device then may download each video segment in sequence using standard HTTP messaging. By utilizing standard HTTP protocols in conjunction with other widely-adopted protocols, such as HyperText Markup Language (HTML) standards, HLS enables conventional web servers to effectively distribute video programs to a wide variety of client devices. However, the HLS standard and other segmentation-based video distribution standards require that a playlist declare the playback duration of each segment identified therein. In addition to this requirement, many client devices require receipt of an HTTP content-length header identifying the data size of the video segment to be received before the client device will playback the segment. As such, a conventional server is required to determine the length of the video segment to be transmitted prior to transmitting the video segment to the client device. To conform to both the fixed-duration segment requirement and the preceding HTTP content-length header requirement, a conventional server caches video segment packets in an internal cache in response to a client request for a corresponding segment in the playlist and calculates the actual aggregate playback duration of the buffered video segments as they are being cached. When the calculated aggregate playback duration of the cached video segment packets reaches the specified playback duration (typically ten seconds) listed for the requested video segment in the playlist, the server determines the aggregate data size of the cached video segment packets and returns this data size as the HTTP content-length header to the client device, and only then commences transmission of the cached video segment packets as the corresponding segment in the following HTTP response entity-body. In this approach, transmission of the first segment of a requested video stream is delayed until ten seconds or some other predetermined playback duration worth of streamed data is cached at the server. The caching of video segment packets sufficient to meet this requirement can take considerable time. To illustrate, in a situation whereby the processing of the video stream is 1× speed (e.g., the video stream being encoded or transcoded from a live feed at 1× speed), it would take ten seconds to buffer video segment packets having an aggregate playback duration often seconds. Even with processing at 2× speed, it would take at least five seconds to buffer a sufficient number of video segment packets to have an aggregate playback duration of ten seconds. This buffering delay between the client request for the initial segment and the eventual initiation of transmission of the requested segment introduces a corresponding delay in the start of playback of the streamed video at the client device, thereby negatively impacting the viewer's experience.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram illustrating a segmentation-based video distribution system in accordance with some embodiments.

FIG. 2 is a block diagram illustrating a segmentation-based video server employing fixed-size video segments in accordance with some embodiments.

FIG. 3 is a flow diagram illustrating a method for streaming fixed-size video segments without collective caching at a server in accordance with some embodiments.

### DETAILED DESCRIPTION

The following description is intended to convey a thorough understanding of the present disclosure by providing a number of specific embodiments and details involving servers employing HTTP Live Streaming (HLS) or other playback-duration-based video segmentation standard. It is understood, however, that the present disclosure is not limited to these specific embodiments and details, which are examples only, and the scope of the disclosure is accordingly intended to be limited only by the following claims and equivalents thereof. It is further understood that one possessing ordinary skill in the art, in light of known systems and methods, would appreciate the use of the disclosed techniques for their intended purposes and benefits in any number of alternative embodiments, depending upon specific design and other needs. Moreover, unless otherwise noted, the figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the disclosed embodiments.

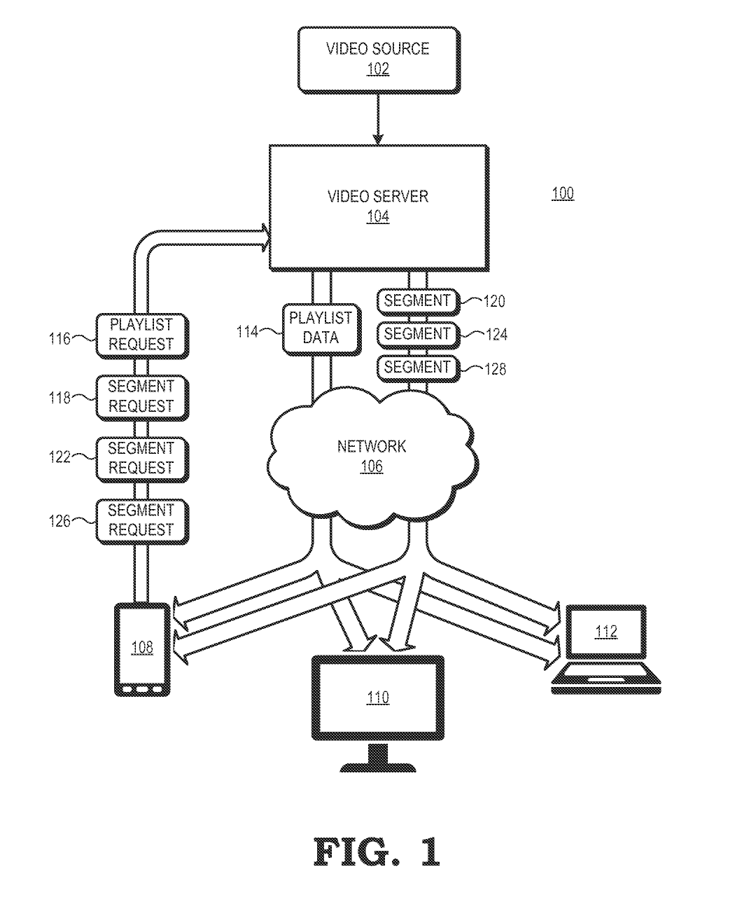

FIGS. 1-3 illustrate example techniques for streaming of video programs from a server to one or more client devices based on a Hypertext Transport Protocol (HTTP) Live Streaming (HLS) standard or other standard that employs playback-duration-based video segmentation and transport protocol-based downloading of the resulting video segments. As described above, a web server using HLS or other such segmentation-based video streaming standards to serve streaming video to client devices typically distributes a playlist or other such index file that advertises a specified playback duration for each video segment listed in the playlist. To serve a requested video segment to a client device using HTTP or other such protocols, the streamed video segment typically is required to be preceded by a content length indicator, such as a HTTP content-length header, indicating the data size of the video segment that follows (as, for example, the HTTP message body). To meet this requirement, a conventional server employs a fixed-duration segmentation scheme whereby the server caches video segment packets until the aggregate playback duration of the cached video segment packets equals the advertised playback duration for the video segment, at which point the server would only then begin streaming the video segment packets to the client device.

The streaming video players employed at client devices typically have the capacity to seamlessly accommodate the processing of video segments that have an actual playback duration that deviates from the playback duration advertised for the video segment in the playlist. Various embodiments of servers described herein leverage this adaptability while conforming to the HTTP content-length header requirement or similar fixed-length indicator requirements by employing a fixed-size segmentation scheme, rather than a fixed-duration segmentation scheme. In this fixed-size segmentation scheme, in response to a client request for a video segment in a distributed playlist, the server estimates the data size of the video segment that would have the playback duration advertised for the video segment in the playlist. The server responds to the request with a HTTP content-length header identifying the estimated segment size and then begins processing the video program to generate segment packets. As each segment packet is generated or otherwise processed by the server, the server writes the segment packet to the HTTP output channel. The server tracks the aggregate amount of data transmitted to the client as part of the streamed video segment. When the aggregate amount of data reaches the estimated segment size provided in the HTTP content-length header that preceded the stream of video segment packets, the server ceases processing of video segment packets for the requested video segment, thereby signaling the end of the video segment.

Under this approach, the server streams the video segment packets when they are ready, rather than collectively caching video segment packets until their aggregate playback duration meets the advertised playback duration and only then transmitting the HTTP content-length header and initiating the streaming of the video segment packets for the requested video segment. This process of transmitting video segment packets once processed, rather than collectively caching video segment packets before initiating streaming, is enabled by the flexibility of the client devices to deal with video segments having actual playback durations that differ from their advertised playback durations. This playback duration flexibility allows estimations of the data size corresponding to a specified playback duration to be made without first caching all of the video segment packets. Thus, under the fixed-size segmentation scheme described herein, the server is able to initiate streaming of video segment packets of a requested video segment to a client device before the entire video segment is cached at the server, thereby reducing the delay in initiation of video stream playback at the client device, which in turn improves the viewer's experience.

For ease of illustration, embodiments of the present disclosure are described in the example context of a web server using an HLS standard to stream a video program to a client device. In accordance with an HLS standard, the web server represents the video program to a client device as a playlist or other index of video segments, and whereby the client device employs HTTP to sequentially access video segments identified in the playlist and decode the accessed video segments at the client device for playback to a viewer. However, the techniques described herein are not limited to a HLS standard or an HTTP standard, but instead may be employed for systems using any of a variety of similar video streaming standards that employ playback-duration-based segmentation, or systems using any of a variety of transport protocol standards that specify that the data size of an object (e.g., a video segment) be transmitted to a receiving device prior to transmitting the object to the receiving device.

FIG. 1 illustrates an example video distribution system 100 employing fixed-size video stream segmentation in accordance with some embodiments. In the depicted example, the video distribution system 100 includes a video source 102, a video server 104, a network 106, and one or more client devices, such as client devices 108, 110, and 112. The video source 102 can comprise any of a variety of sources or feeds of live or pre-recorded video programs, such as a broadcast cable network, a broadcast satellite network, a broadcast television network, an Internet Protocol (IP) television distribution system, a broadcast mobile network, a video conferencing service or other source of live video. Examples of pre-recorded video sources include video-on-demand (VOD) sources such as an Internet-based video source, such as YouTube™, Hulu™, Netflix™, a cable or IP television video on demand network, a digital video recorder, a video camera, a personal computer or other source of stored video. Examples of live video programs include broadcast television network programs, broadcast cable network programs, and the like. The video server 104 comprises a web-based server that streams video programs to the one or more clients 108-112 via the network 106, which can include the Internet, a wired or wireless local area network (LAN), a wired or wireless wide area network (WAN), and the like, or a combination of such networks. The client devices 108-112 can comprise any of a variety of HLS-enabled client devices, such as computing-enabled cellular phones (e.g., “smartphones”), tablet computers, notebook computers, personal computers, set-top boxes, gaming consoles, Internet-enabled televisions, and the like.

As a general overview, the video server 104 operates to encode a live or pre-recorded video program from the video source 102 and stream the resulting encoded video program to one or more of the client devices 108-112. As part of this process, the video server 104 implements an HLS standard so as to enable streaming of the encoded video program as a sequence of Motion Pictures Experts Group-2 (MPEG2) transport stream segments, each of which may be separately downloaded from the video server 104 by a client device using standard HTTP request and response messaging. To facilitate this process the video server 104 generates a playlist 114 (e.g., an index file) comprising data listing a set of one or more video segments for the video program that are available to be downloaded from the video server 104. As specified by the HLS standard, a playlist is designated as a file with a file extension “.m3u8”. Table 1 below illustrates a simple example of the playlist 114 for three unencrypted MPEG2 transport stream video segments (denoted as “segment 1.ts”, “segment2.ts”, and “segment3.ts”) of a video program:

TABLE 1
Example HLS Playlist 114

| | |
|---|---|
| (1) | #EXTM3U |
| (2) | #EXT-X-VERSION:3 |
| (3) | #EXT-X-TARGETDURATION:10 |
| (4) | #EXTINF:10,http://server/segment1.ts |
| (5) | #EXTINF:10,http://server/segment2.ts |
| (6) | #EXTINF:10,http://server/segment3.ts |
| (7) | #EXT-X-ENDLIST |

Line (3), “#EXT-X-TARGETDURATION:10”, specifies a maximum playback duration of 10 seconds for all video segments listed in the playlist 114. The listing of each video segment in the playlist 114 takes the form of: “#EXTINF:<advertised playback duration in seconds>, <URI of transport stream segment>”. Thus, line (4), “#EXTINF: 10, http://server/segment1.ts” specifies the first video segment in the playlist 114 has an advertised playback duration of 10 seconds and can be downloaded or otherwise accessed via an HTTP request to the location “//server/segment1.ts”. Likewise, line (5), “#EXTINF: 10, http://server/segment2.ts” specifies the second video segment in the playlist 114 has an advertised playback duration of 10 seconds and can be downloaded or otherwise accessed via an HTTP request to the location “//server/segment2.ts”. Similarly, line (6), “#EXTINF: 10, http://server/segment3.ts” specifies the third video segment in the playlist 114 has an advertised playback duration of 10 seconds and can be downloaded or otherwise accessed via an HTTP request to the location “//server/segment3.ts”.

The process of serving the segmented video program to a client device is illustrated using the client device 108 as an example. Similar processes may be performed by the other client devices 110 and 112. When a viewer interacts with a video player application at the client device 108 to indicate the viewer's desire to view a video program, the client device 108 initiates a request for the playlist 114 associated with the video program identified by the viewer. To illustrate, the video player application may include a web browser compliant with the HTML5 standard, and the viewer may navigate the web browser to a web page with a <video> tag linked to the video program. Table 2 illustrates a simple example of HTML code in a web page that initiates the sequential download and playback of a segmented video program:

TABLE 2
Example HTML5 code

| | |
|---|---|
| (1) | <html> |
| (2) | <body> |

| | |
|---|---|
| (3) | <video |

| | |
|---|---|
| (4) | src=“http://server/playlist.m3u8” |
| (5) | height=“300” width=“400” |

| | |
|---|---|
| (6) | > |
| (7) | </video> |

| | |
|---|---|
| (8) | </body> |
| (9) | </html> |

The <video> tag at lines (3)-(7) of the HTML5 code signals the web browser to access the playlist 114 located at the URL “//server/playlist.m3u8” using a playlist request in preparation for video playback of the video program represented by the playlist. Using this URL, the web browser accesses the playlist 114 using a playlist request 116 (in the form of an HTTP GET request to the identified URL).

Upon receipt of the playlist 114, the web browser at the client device 108 sequences through the video segments indexed by the playlist 114. To illustrate, upon processing line (4) of the playlist 114 represented by Table 1, the web browser issues a segment request 118 (in the form of an HTTP GET request to the specified URL “//server/segment1.ts”), in response to which the video server 104 transmits the requested first video segment 120 (“segment 1.ts”) to the client device 108 as one or more HTTP headers and a HTTP response body containing transport stream packets (one example of video segment packets) comprising the first video segment 120. The video player application at the client device 108 decodes the video segment 120 (and decrypts it if received in encrypted form) and provides the resulting video and audio content for playback via a video player embedded in, or associated with, the web browser. While receiving or decoding the video segment 120, the video player application at the client device 108 can process line (5) of the playlist 114 represented by Table 1 to initiate downloading of the second video segment 124 (“segment2.ts”) via a segment request 122 in the form of a HTTP GET request. During the downloading or decoding of the second video segment 124, the video player application can process line (6) of the playlist 114 represented by Table 1 to initiate downloading of the third video segment 128 (“segment3.ts”) via a segment request 126. This process of downloading or otherwise accessing a transport stream segment and decoding the accessed transport stream segment for playback at the client device 108 may be repeated in some sequence for some or all of the video segments indexed in the playlist 114.

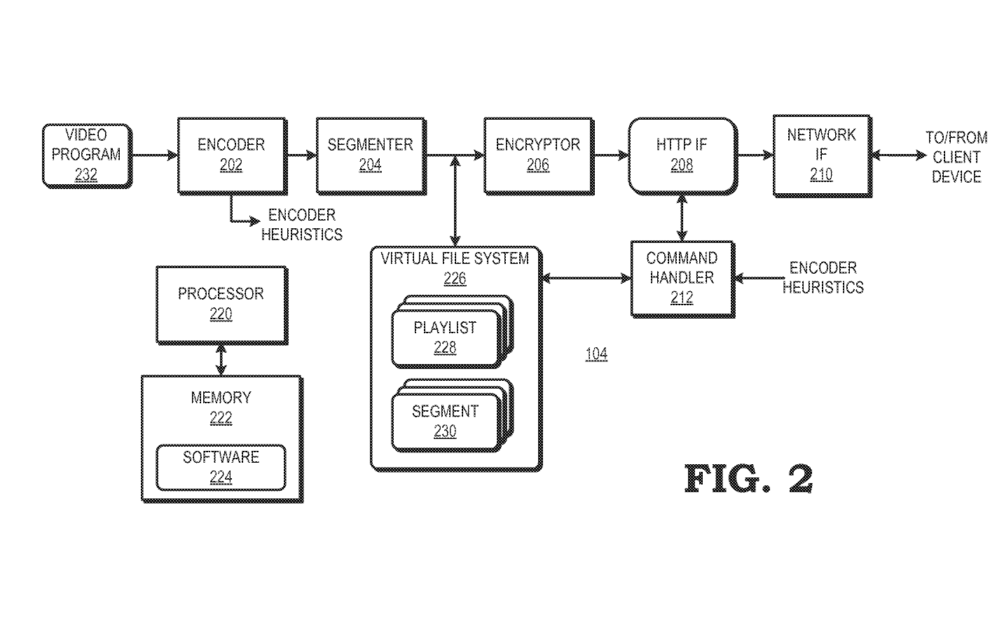

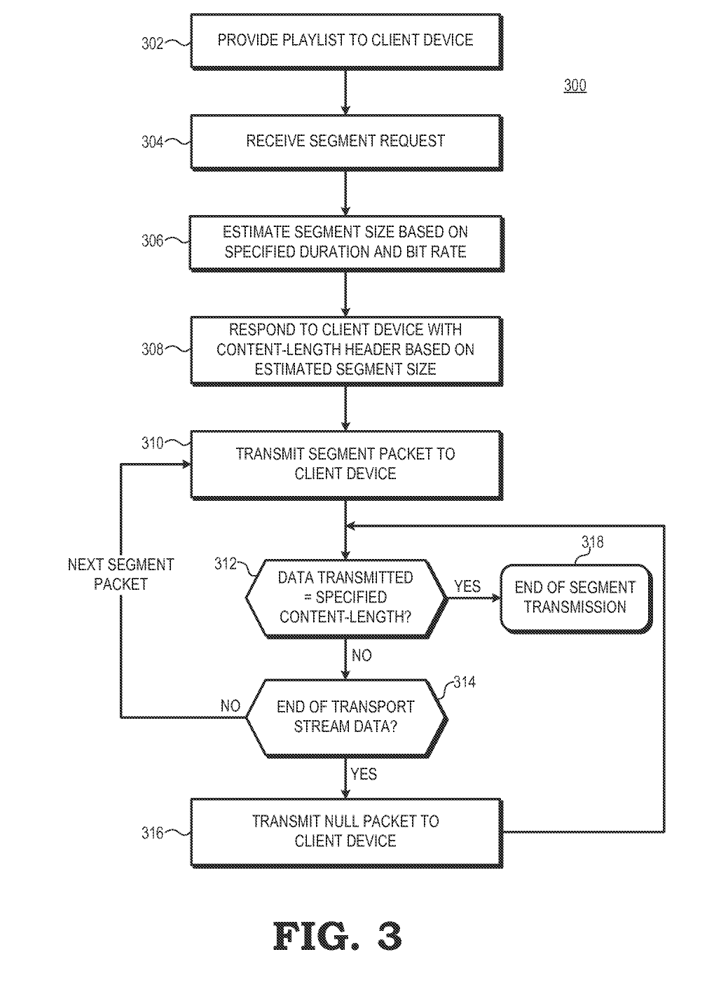

The HTTP protocol provides for a content-length header to precede the body of an HTTP response, whereby the content-length header specifies the size, in bytes, of the data transmitted in the body of the HTTP response. Many HLS-enabled video player applications expect this content-length header when receiving a transport stream segment and will not process a transport stream segment without first receiving this header. To avoid the delayed streaming resulting from the conventional fixed-duration segmentation scheme employed by conventional video servers, in some embodiments the video server 104 instead employs a fixed-size segmentation scheme whereby the video server 104 estimates the data size of a requested video segment based on its advertised playback duration and then provides this estimated segment size as the content-length header and starts streaming video segment packets for the requested video segment without first collectively caching the video segment packets to confirm they have an aggregate playback duration equal to the advertised duration. As such, the video server 104 can begin streaming video segment packets as a video segment to the client device 108 soon after receiving the video segment request from the client device 108. Embodiments of this fixed-size segmentation scheme are described in greater detail below with reference to FIGS. 2 and 3.

FIG. 2 illustrates an example implementation of the video server 104 in accordance with some embodiments. In the depicted example, the video server 104 includes a video encoder 202, a stream segmenter 204, a segment encryptor 206, an HTTP interface 208, a network interface 210, a command handler 212, and a rate control module 214. Certain components of the video server 104 may be implemented exclusively in hardcoded or hardwired hardware, such as in an application specific integrated circuit (ASIC), whereas other components of the video server 104 may be implemented via one or more processors 220 and a memory 222 or other non-transitory computer readable medium that stores one or more software programs 226 that comprise executable instructions that, when executed, manipulate the one or more processors 220 to perform various functions described herein. For example, the video encoder 202 may be implemented as a hardware-implemented MPEG-4 (H2.264 video and AAC audio) encoder, whereas the stream segmenter 204, the segment encryptor 206, the HTTP interface 208, and the command handler 212 are implemented as the one or more processors 220 executing one or more software programs 226. In such instances, the stream segmenter 204, segment encryptor 206, and command handler 212 may be implemented as application software (one example of software program 224), whereas the HTTP interface 208 is implemented as protocol stack software that is part of an operating system (OS) executed at the video server 104 (another example of the software program 224).

The processor 220 can include, for example, a microprocessor, a micro-controller, a digital signal processor, a microcomputer, a central processing unit, a field programmable gate array, a programmable logic device, a state machine, logic circuitry, analog circuitry, digital circuitry, or any other device that can be manipulated by the execution of software instructions stored in the memory 222. The memory 222 can include any of a variety of non-transitory computer readable media for storing the software program, such as a hard disc drive, solid state hard drive, read-only memory, random access memory, volatile memory, non-volatile memory, static memory, dynamic memory, flash memory, cache memory, and the like.

As noted above, the video server 104 operates to serve segmented video streams to client devices through the implementation of HLS-based and HTTP-based protocols. As the video server 104 may offer a number of video programs for streaming to client devices, and considerable resources typically are needed to encode or transcode a video program to comply with a particular bitrate or particular encoding scheme, the video server 104 typically does not initiate the encoding/transcoding and segmentation process until a video server 104 submits a request for the video program to be streamed to the client device. To this end, the video server 104 implements a virtual file system 226 to store one or more playlists 228 for each video program available from the video server 104 and to act as a virtual repository for the (yet-to-be-generated) video segments 230 referenced by the playlists 228. To illustrate, the video server 104 may be able to provide different streamed versions of a given video program, such as at a different bitrate, display resolution, or encoding scheme, and the video server 104 may maintain a separate playlist 228 for each available variation (such playlists commonly being referred to as “variant playlists.”)

Each playlist 228 for a given video program includes an indexed list of video segments 230 for the corresponding video program, with each entry of the list including a playback duration indicator (e.g., the “EXTINF:<duration in seconds>” indicator as described above with reference to the example playlist 114 of Table 1) and a URI identifying the relative or absolute location where the corresponding video segment 230 can be found in the virtual file system 226. However, because in some embodiments the video segments 230 are generated on demand, the URIs for video segments 230 referenced in the playlist 228 are “placeholders” in that the video segment 230, once generated, subsequently will be associated with the indicated location.

In operation, the streaming process for a video program to a client device initiates when the client device requests a playlist 228 for an identified video program 232. To obtain the playlist 228, the client device transmits a HTTP request for the playlist 228 to the video server 104 via the network 106 (FIG. 1) using, for example, a process like that described above with reference to Table 2. At the video server 104, the network interface 210 forwards the HTTP request data to the HTTP interface 208, which opens an HTTP output channel or HTTP session and forwards the relevant content from the HTTP request to the command handler 212. The command handler 212 coordinates the encoding and encryption processes for streaming a video program to a client device. Accordingly, in response to the HTTP request for the playlist 228, the command handler 212 accesses the playlist 228 and forwards the playlist 228 to the HTTP interface 208, which transmits the playlist 228 for reception by the client device as a HTTP response over the opened HTTP output channel.

The client device the selects an initial video segment 230 from the indexed list of video segments 230 represented in the playlist 228 and transmits an HTTP request for the URI listed in association with the selected initial video segment 230. Upon receipt, the HTTP interface 208 forwards the HTTP request to the command handler 212. In response to the segment request, the command handler 212 directs the video encoder 202 to initiate encoding (or transcoding) of the video program 232 at the appropriate playback location in accordance with the bitrate or other encoding parameters associated with the playlist 228. The resulting stream of encoded MPEG2 transport stream packets is then segmented by the stream segmenter 204 into a sequence of video, or transport stream, segments 230, including the requested initial video segment 230. In some instances, the video server 104 may employ an encryption scheme to secure the video content from unauthorized access, in which case the video segments 230 may be encrypted by the segment encryptor 206 using one or more encryption keys stored in, for example, the virtual file system 226. The command handler 212 then coordinates the provision of the requested initial video segment 230 to the HTTP interface 208, whereupon the initial video segment 230 is transmitted by the HTTP interface 208 over the opened HTTP output channel for reception by the client device via the network interface 210 and the network 106.

As noted above, the playlist 228 advertises or otherwise specifies a playback duration of each listed video segment. As also noted above, the client device typically adheres to a requirement that an accurate HTTP content-length header precede the HTTP body it represents. In a conventional fixed-duration segmentation scheme, a video server ensures that this HTTP content-length header requirement is met by collectively caching video segment packets until the aggregate playback duration of the cached video segment packets is equal to the advertised playback duration, at which point the video server calculates the aggregate data size of the cached video segments, provides this calculated data size as the HTTP content-length header, and then streams the collectively cached video segment packets as the corresponding video segment. This approach can lead to significant delays in stream initiation as it requires the server to wait for a sufficient number of video segment packets to be cached before transmission can begin. Accordingly, in some embodiments, a fixed-size segmentation scheme is instead employed whereby the stream segmenter 204, HTTP interface 208, and command handler 212 coordinate to estimate the data size of a video segment that would have the advertised playback duration, issue a HTTP content-length header based on this estimated segment size, and then initiating the transmission of a set of video segment packets that, in the aggregate, has the estimated segment size. This approach segments the video program into fixed-size segments, rather than fixed-playback-duration segments, which permits the video server 104 to begin streaming video segment packets as they become available, rather than first collectively caching a set of video segment packets before transmission can be initiated.

FIG. 3 illustrates an example method 300 for implementing this fixed-size segmentation scheme in the implementation of the video server 104 of FIG. 2 in accordance with some embodiments. The method 300 initiates at block 302 with the provision of the playlist 228 for the video program 232 to a client device, such as the client device 108 (FIG. 1). The client device identifies a video segment from the playlist 228 and sends a segment request for the identified video segment in the form of, for example, an HTTP request. At block 304, the HTTP interface 208 receives the segment request, opens an HTTP session our output HTTP channel with the client device, and forwards the segment request to the command handler 212. In response to the segment request, the command handler 212 initiates the encoding and encryption process to generate a stream of video segment packets for transmission as the requested video segment. As part of this process, at block 306 the command handler 212 determines the playback duration that was specified in the playlist 228 for the requested video segment and then estimates a data size of a video segment having the specified playback duration in accordance with the current encoding heuristics of the video encoder 202. Such encoding heuristics can include, for example, a bit rate of the encoded video stream output by the video encoder 202 (if encoded at a constant bit rate) or a maximum/minimum bitrate or average bit rate (if encoded at a variable bit rate). In a typical implementation, the format of the encoded video stream is a MPEG2 transport stream, which is comprised of packets of 188 bytes. Accordingly, the estimated segment size can be rounded to the nearest packet-size multiple. Thus, the estimated segment size may be calculated in accordance with the following equation:

$$Est\_Seg \_Size = ⌈ \frac{Current\_Enc \_Bittrate \times Advertised\_Duration}{8} ⌉$$

where Est_Seg_Size represents the estimated segment size in bytes (rounded to the nearest 188 byte multiple), Current_Enc_Bitrate represents the current bit rate (or current averaged bit rate) of the video encoder 202, and Advertised_Duration represents the playback duration of the video segment, in seconds, as specified in the corresponding playlist 228. To illustrate, assuming an advertised playback duration of 10 seconds (Advertised_Duration=10 seconds), an encoding bitrate of 1 megabit/second (Current_Enc_Bitrate=1,000,000 bits/second), the raw estimated segment size would be calculated as 1,250,000 bytes, which would then be rounded up to the nearest 188 byte multiple, resulting in an estimated segment size of 1,250,012 bytes (Est_Seg_Size=1,250,012 bytes).

Upon calculation of the estimated segment size, at block 308 the command handler 212 directs the HTTP interface 208 to generate a HTTP content-length header specifying the estimated segment size (e.g., 1,250,012 bytes in the example above) and respond to the segment request from the client device by transmitting the HTTP content-length header for reception by the client device via the open HTTP session.

After transmitting the HTTP content-length header, the video server 104 begins streaming for reception by the client device the video segment packets (e.g., transport stream packets) that are to represent the requested by the client device as they become available from the stream segmenter 204 or the segment encryptor 206. In at least one embodiment, the video server 104 initiates a byte counter and iteratively processes and writes out video segment packets onto the HTTP output channel until the byte counter indicates that the stream of video segment packets has reached an aggregate data size equal to the estimated segment size. This process is represented by blocks 310, 314, 316, and 318, described below.

At block 310 the command handler 212 directs the stream segmenter 204 and segment encryptor 206 (when encryption is implemented) to generate a video segment packet and provide the video segment packet to the HTTP interface 208, which then transmits the video segment packet for reception by the client device via the open HTTP session without first collectively caching video segment packets. At block 312, the command handler 212 determines whether the aggregate data size of video segment packets transmitted for the requested video segment has reached the estimated segment size. In one embodiment, this status is maintained through the use of a byte counter which is initialized for the start of transmission of a requested video segment. For each video segment packet transmitted in accordance with block 312, the byte counter is adjusted to reflect the size of the video segment packet so transmitted. For a decrement byte counter, the byte counter can be set to an initial value based on the estimated segment size and then decremented (by one if counting by video segment packets, or by 188 if counting by bytes). When the decrementing byte counter reaches zero, a status signal is asserted, thereby indicating that a set of video segment packets having a collective data size equal to the estimated segment size.

In the event that the total amount of data transmitted for the current video segment has not reached the estimated segment size, a complete video segment has not yet been transmitted. Accordingly, the video server 104 continues to prepare the next video segment packet for transmission. However, in certain instances, such as when the video server 104 is approaching the end of the video program 232, there may not be sufficient video content to generate a number of video content packets sufficient to reach the specified estimated segment size. Accordingly, at block 314 the command handler 212 determines whether the video server 104 has reached the end of the video program 232 before a complete video segment could be transmitted (that is, a video segment having a size equal to the size specified in the HTTP content-length header preceding the video segment). If so, at block 316 the remainder of the video segment can be padded by outputting MPEG2 transport stream NULL packets (having a packet identifier of 0x1FF) for the remainder of the video segment until the total amount of data transmitted (including both actual video content and NULL packets) reaches the data size specified in the HTTP content-length header. Otherwise, if the end of the video program 232 has not been reached or there otherwise is sufficient video data to generate another video segment, the method flow returns to block 310 for another iteration of the video segment packet transmission process.

When it is determined at an iteration of block 312 that the aggregate amount of data transmitted via the stream of video segment packets has reached the estimated segment size reflected in the transmitted HTTP content-length header (e.g., the decrement byte counter has reached zero), the video server 104 has completed transmission of the requested video segment to the client device. Accordingly, the method 300 continues to block 318, whereupon the command handler 212 directs the video encoder 202, stream segmenter 204, and segment encryptor 206 to cease processing of video segment packets for the requested video segment. In the process described above, the video segment packets intended to represent the requested video segment are output to the HTTP output channel without any form of collective caching of multiple video segment packets, as is conventionally required in order to determine the segment size for the conventional fixed-duration segmentation scheme. As such, by employing the fixed-size segmentation scheme described above, there is relatively little delay between the time of receipt of the video segment request from the client device and the start of transmission of video segment packets to the client device. This minimal delay results in a faster start to the playback of video at the client device, and thus provides an improved viewer experience.

In this document, relational terms such as first and second, and the like, may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element. The term “another”, as used herein, is defined as at least a second or more. The terms “including” and/or “having”, as used herein, are defined as comprising. The term “coupled”, as used herein with reference to electro-optical technology, is defined as connected, although not necessarily directly, and not necessarily mechanically.

The specification and drawings should be considered as examples only, and the scope of the disclosure is accordingly intended to be limited only by the following claims and equivalents thereof. Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A method comprising:
receiving, at server, a request for a video segment of a video program from a client device;
transmitting, from the server, a content length indicator for reception by the client device in response to the request, the content length indicator representing an estimated segment size of the video segment based on a specified playback duration associated with the video segment; and
streaming, from the server, a set of video segment packets of the video program for reception by the client device as the requested video segment, wherein the streamed set of video segment packets has an aggregate data size equal to the estimated segment size.

2. The method of claim 1, wherein streaming the set of video segment packets of the video program for reception by the client device as the requested video segment comprises:
generating video segment packets at the server and transmitting the video segment packets from the server for reception by the client device until the number of video segment packets transmitted equals a number of video segment packets corresponding to the estimated segment size and wherein the server initiates streaming of the set of video segment packets without first collectively caching the set of video segment packets.

3. The method of claim 1, further comprising:
in response to a remaining portion of the video program being less than the estimated segment size:
transmitting video segment packets representing the remaining portion of the video program from the server for by receipt by the client device without first collectively caching the video packet segments; and
transmitting null packets from the server for reception by the client device as part of the video segment until the sum of the number of video segment packets transmitted and the number of null packets transmitted equals the number of video segment packets corresponding to the estimated segment size.

4. The method of claim 1, further comprising:
transmitting, from the server, playlist data for reception by the client device, the playlist data comprising an identifier of the video segment and a playback duration identifier indicating the video segment has the specified playback duration.

5. The method of claim 4, wherein:
the request comprises a Hypertext Transport Protocol (HTTP) request;
the content length indicator comprises a HTTP content-length header;
the video segment comprises a Motion Pictures Experts Group (MPEG) transport stream segment; and
the playlist data comprises a HTTP Live Streaming (HLS) playlist.

6. The method of claim 1, further comprising:
determining the estimated segment size of the video segment based on a bitrate heuristic of the video program and the specified playback duration.

7. The method of claim 1, wherein:
the request comprises a Hypertext Transport Protocol (HTTP) request;
the content length indicator comprises a HTTP content-length header; and
the video segment comprises a Motion Pictures Experts Group (MPEG) transport stream segment.

8. A server comprising:
a network interface to communicatively couple with a client device via a network;
a transport protocol interface to manage request and response transmissions with the client device via the network interface in accordance with a transport protocol; and
wherein the server is to:
provide a content length indicator for transmission to the client device via the transport protocol interface in response to a request for a video segment of a video program from the client device, the content length indicator comprising an estimated segment size of the video segment based on a specified playback duration associated with the video segment; and
stream, via the transport protocol interface, a set of video segment packets of the video program for reception by the client device as the requested video segment, wherein the streamed set of video segment packets has an aggregate data size equal to the estimated segment size.

9. The server of claim 8, wherein the server is to stream the set of video segment packets of the video program by:
transmitting, via the transport protocol interface, video segment packets for reception by the client device until the number of video segment packets transmitted equals a number of video segment packets corresponding to the estimated segment size; and
wherein the server initiates streaming of the set of video segment packets without first collectively caching the set of video segment packets.

10. The server of claim 8, wherein the server is to stream the set of video segment packets of the video program by:
in response to a remaining portion of the video program being less than the estimated segment size:
transmitting, via the transport protocol interface, video segment packets representing the remaining portion of the video program from the server for by receipt by the client device wherein the server initiates streaming of the set of video segment packets without first collectively caching the set of video segment packets; and
transmitting null packets from the server for reception by the client device as part of the video segment until the sum of the number of video segment packets transmitted and the number of video segment packets transmitted equals the number of video segment packets corresponding to the estimated segment size.

11. The server of claim 8, wherein the server further is to transmit, via the transport protocol interface, playlist data for reception by the client device, the playlist data comprising an identifier of the video segment and a playback duration identifier indicating the video segment has the specified playback duration.

12. The server of claim 11, wherein:
the request comprises a Hypertext Transport Protocol (HTTP) request;
the content length indicator comprises a HTTP content-length header;
the video segment comprises a Motion Pictures Experts Group (MPEG) transport stream segment; and
the playlist data comprises a HTTP Live Streaming (HLS) playlist.

13. The server of claim 8, wherein the server further is to determine the estimated segment size of the video segment based on a bitrate heuristic of the video program and the specified playback duration.

14. The server of claim 8, wherein:
the transport protocol interface comprises a Hypertext Transport Protocol (HTTP) manager;
the request comprises a Hypertext Transport Protocol (HTTP) request;
the content length indicator comprises a HTTP content-length header; and
the video segment comprises a Motion Pictures Experts Group (MPEG) transport stream segment.

15. A non-transitory computer readable medium tangibly embodying a set of executable instructions, the set of executable instructions, when executed, are to manipulate at least one processor of a server to:
provide a content length indicator for transmission to a client device in response to a request for a video segment of a video program from the client device, the content length indicator comprising an estimated segment size of the video segment based on a specified playback duration associated with the video segment; and
provide a set of video segment packets of the video program for streaming to the client device as the requested video segment, wherein the streamed set of video segment packets has an aggregate data size equal to the estimated segment size.

16. The non-transitory computer readable medium of claim 15, wherein the set of executable instructions to manipulate at least one processor of the server to provide the set of video segment packets of the video program for streaming comprise executable instructions to manipulate at least one processor of the server to:
generate video segment packets and provide the video segment packets for transmission for reception by the client device until the number of video segment packets transmitted equals a number of video segment packets corresponding to the estimated segment size and wherein the server initiates streaming of the set of video segment packets without first collectively caching the set of video segment packets.

17. The non-transitory computer readable medium of claim 15, wherein the set of executable instructions further comprises executable instructions to manipulate at least one processor of the server to:
in response to a remaining portion of the video program being less than the estimated segment size:
provide video segment packets representing the remaining portion of the video program for transmission to the client device without first collectively caching the video packet segments; and
provide null packets for transmission to the client device as part of the video segment until the sum of the number of video segment packets transmitted and the number of null packets transmitted equals the number of video segment packets corresponding to the estimated segment size.

18. The non-transitory computer readable medium of claim 15, wherein the set of executable instructions further comprises executable instructions to manipulate at least one processor of the server to:
provide playlist data for transmission to the client device, the playlist data comprising an identifier of the video segment and a playback duration identifier indicating the video segment has the specified playback duration.

19. The non-transitory computer readable medium of claim 18, wherein:
the request comprises a Hypertext Transport Protocol (HTTP) request;
the content length indicator comprises a HTTP content-length header;
the video segment comprises a Motion Pictures Experts Group (MPEG) transport stream segment; and
the playlist data comprises a HTTP Live Streaming (HLS) playlist.

20. The non-transitory computer readable medium of claim 15, wherein the set of executable instructions further comprises executable instructions to manipulate at least one processor of the server to:
determine the estimated segment size of the video segment based on a bitrate heuristic of the video program and the specified playback duration.
